(19) United States
(12) Patent Application Publication
(10) Pub. No.: US 2009/0271043 A1
(43) Pub. Date: Oct. 29, 2009

(54) Multiple Electronic Control Unit for Differentiated Control of Solenoid Valves in Watering Systems

(76) Inventor: Gianfranco Roman, Pasiano (IT)

Correspondence Address: JACOBSON HOLMAN PLLC, 400 SEVENTH STREET N.W., SUITE 600, WASHINGTON, DC, 20004, US

(21) Appl. No.: 11/922,225

(22) PCT Filed: Dec. 5, 2005
(86) PCT No.: PCT/EP2005/056476

§ 371 Date: Dec. 14, 2007

(30) Foreign Application Priority Data
Jun. 21, 2005 (IT) MI2005A001167

(51) Int. Cl. G05D 7/06; G05B 19/02; A01G 25/16; F16K 31/02; G08B 3/00

(52) U.S. Cl. 700/284; 137/624.13; 340/691.4

(57) ABSTRACT

An electronic control unit for control of solenoid valves in watering systems is described, comprising a plurality of knobs (101) for the selection and the time-setting of respective solenoid valves (102) in a watering cycle, and at least one additional period knob (104) for defining the frequency of activation of said solenoid valves (102) in said watering cycle.

The present invention concerns a multiple electronic control unit for differentiated control of solenoid valves in watering systems.

In order to cyclically water in a regular way lands with a considerable dimension it is necessary to avail of programmable watering systems, made up of a plurality of solenoid valves, each one of which controls a respective set of sprayers capable to water a certain zone of said land.

The systems currently on the market comprise a programmable control unit which is capable to carry out a great number of functions but it is not of an immediate use for a common user.

Only a skilled technician is capable to carry out finer adjustments, that is differentiating the turning on/turning off time for each solenoid valve.

Usually the turning on/turning off times for each solenoid valve are set up by the technician as a function of the season in which it is operated.

It is known that the climate varies a lot during the year, so that the water necessary to a land varies considerably.

In addition each land, in particular if we consider gardens or parks with trees, has more or less sun lit zones with a consequent different water requirement that, as mentioned above, varies also during the year.

The user must therefore face two variables: the exposure of each zone of the land and the climatic period of the year.

In addition, in a same period it is possible to have short periods that are more or less sun lit or even with intermittent rain insufficient to satisfy the water requirements of the land but such as to make the water supplied by the previously set up system excessive.

Finally hopefully the same control unit can be used without problems with a variable number of solenoid valves.

Object of the present invention is to provide an electronic control unit that allows to an average non-skilled user to differentiate easily and immediately the turning on/turning off time and the time-setting for each solenoid valve of the watering system.

According to the invention, such object is attained with an electronic control unit for the control of solenoid valves in watering systems, characterised in that it comprises a plurality of knobs for the selection and the time-setting of respective solenoid valves in a watering cycle, and at least one additional period knob for defining the frequency of activation of said solenoid valves in said watering cycle.

The normal user can thus adjust and then modify by rotation of the single knobs the program set up for the single solenoid valves of the watering system.

These and other characteristics of the present invention will be made evident from the following detailed description of an embodiment thereof which is illustrated as a non limiting example in the enclosed drawings , in which:

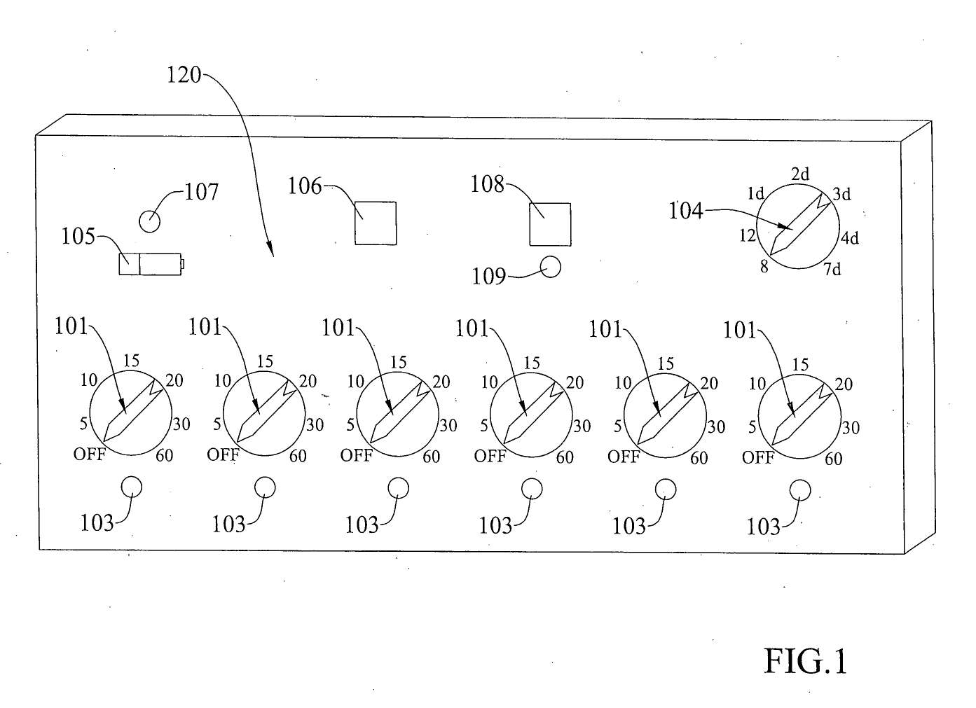

FIG. 1 shows an axonometry view of the control unit according to the present invention;

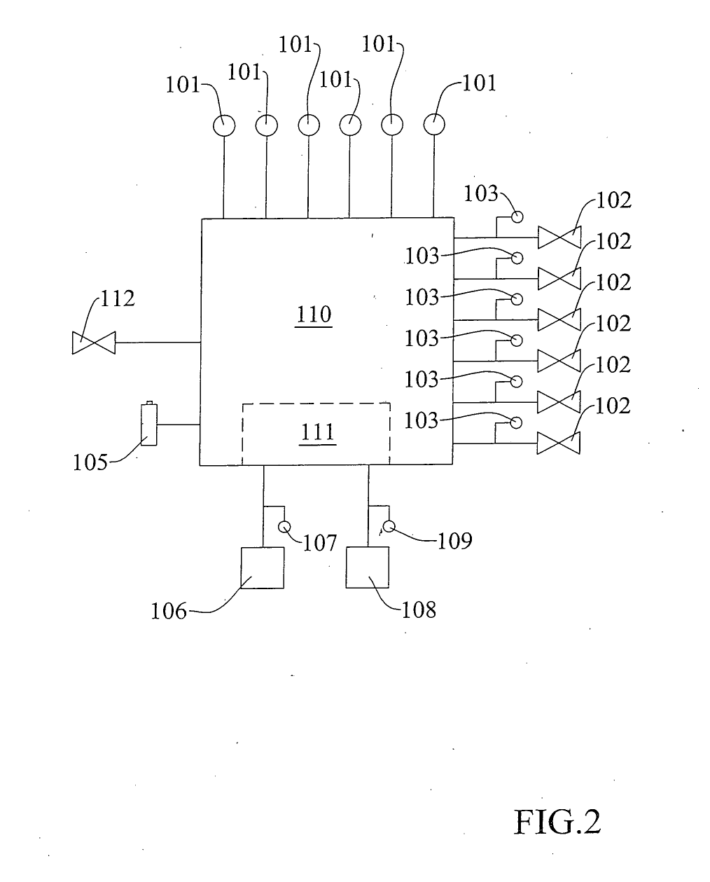

FIG. 2 shows a schematic representation of a control circuit of the control unit.

The electronic control unit shown in the drawings comprises on a front control panel 120 a plurality of knobs 101 for the selection of respective solenoid valves 102 (FIG. 2). To each knob 101 a luminous LED 103 is in addition associated.

Each knob 101 has alphanumeric references which allow the user to establish which solenoid valves 102 are selected and for which duration as compared with the periods of opening of the same solenoid valves.

The control unit comprises in addition a period knob 104 capable to establish the frequency of activation of the cycle being set up, that is every how much time the cycle will be automatically started. Also in this case alphanumeric references present around knob 104 allow the user an easy set-up.

FIG. 1 finally shows a battery state signaller 105, a start push-button 106 with relative luminous LED 107 and a delayed start push-button 108 (for example, six hours) with relative luminous LED 109.

The signaller 105 is obviously necessary if the control unit is supplied in direct current by a battery. If the control unit is supplied with alternating current, there is however present a safety battery which enters in operation in case of a failure of the main alternating current supply.

In the case of direct current supply, possible supply problems will be signalled by the LED 107 that gets illuminated in red.

A control circuit of the control unit shown in FIG. 2 comprises a microprocessor 110, with system clock 111, which allows to. control according to the set-up program, in addition to the solenoid valves 102, also a main valve or “master valve” 112 positioned upstream of said solenoid valves 102 nearby the pump for the supply of water (not shown).

The set-up and the start of a watering cycle is very simple. Starting from the situation with the system turned off, the user selects the desired solenoid valves, that is. certain sets of sprayers of the watering system (not shown), by rotating the knobs 101. The figures associated with each knob 101 represent the operating times of the corresponding solenoid valve 102. If one or more solenoid valves are excluded from the watering cycle, or even if they are not provided in the system managed by the control unit, the relative knobs 101 are left in OFF position.

Once the solenoid valves 102 have been selected and their time set-up, it is necessary to set up the frequency of activation of the cycle by rotating the knob 104.

The system is now ready to be started. By pressing the start push-button 106 (the LED 107 gets illuminated in green) automatically a start instant for the cycle is defined according to which the system clock 111 will define the opening in sequence of the solenoid valves 102 according to the program being set up. The LED1 103 associated with the selected solenoid valves 102 get illuminated in green when the relative solenoid valve 102 gets opened. The watering cycle automatically skips the solenoid valves corresponding to the knobs in OFF position.

In the case in which one wants to start the cycle in a subsequent moment, as for instance after six hours, the delayed start push-button 108 is to be pressed with consequent lighting up of the associated LED 109 (it gets illuminated in green).

Before opening the solenoid valves 102, the microprocessor 110 will provide to open the “master valve” 112, which at the end of each cycle will get closed after the closing of the last selected solenoid valve 102.

If after a certain period the user decides to vary the cycle, if the system is off he can rotate the knobs 101 and 104 as he likes. In order to set up the start moment he will have to press the start push-button 106 or the delayed start button 108 again.

If the system is on, that is if it is in a programmed cycle, in order to interrupt the same cycle the push-buttons 106 and 108 must be pressed at the same time. The LED 107 and the LED 103 of the solenoid valve opened in that moment get illuminated in red instead of green to signal a non-customary event.

In order to unlock the control unit the cycle must be re-set again and the start push-button 106 (or the one of delayed start 108) must be pressed again.

The average user can therefore simply set up the desired cycle without having to make sophisticated adjustments.

The interface offered by the panel 120 of the control unit shown in FIG. 1 is immediately understandable. The expert maintenance personnel will have to be called for example only in the case of malfunction (problems with current supply).

Owing to the above described control unit the changes of season will not be a problem any more. The land will receive in each period of the year the right quantity of water in each specific zone with consequent saving in water.

The average user will be in addition capable to quickly react to sudden changes in the climatic conditions beyond the aforesaid seasonal variations.

1. Electronic control unit for control of solenoid valves in watering systems, characterised in that it comprises a plurality of knobs (101) for the selection and the time-setting of respective solenoid valves (102) in a watering cycle, and at least one additional period knob (104) for defining the frequency of activation of said solenoid valves (102) in said watering cycle.

2. Control unit according to claim 1, characterised in that it comprises a microprocessor (110) with system clock (111).

3. Control unit according to claim 1, characterised in that it controls at the beginning of cycle the opening of a main valve or “master valve” (112) positioned upstream of said solenoid valves (102).

4. Control unit according to claim 1, characterised in that it is supplied with direct current.

5. Control unit according to claim 1, characterised in that it is supplied with alternating current.

6. Control unit according to claim 1, characterised in that it is supplied with alternating current with safety battery in direct current.

7. Control unit according to claim 1, characterised in that said control push-buttons comprise a start push-button (106) and a delayed start push-button (108).

8. Control unit according to claim 7, characterised in that said delayed start push-button (108) allows a six hours delayed start of the programmed cycle.

9. Control unit according to claim 7, characterised in that the simultaneous operation of the start push-button (106) and of the delayed start push-button (108) allows the interruption of an operating cycle and the re-set of the same cycle.

10. Control unit according to claim 1, characterised in that said signallers of state comprise luminous LEDs (103) associated with each knob (101) controlling a respective solenoid valve (102), a start luminous LED (107) of an operating cycle, a luminous delayed start LED (109) and a battery state signaller (105).

11. Control unit according to claim 1, characterised in that each one of said selection and time-setting knobs (101) provides an OFF position which excludes the respective solenoid valve (102) from the watering cycle being set up.
